(19) United States
(12) Patent Application Publication
(10) Pub. No.: US 2013/0346843 A1
(43) Pub. Date: Dec. 26, 2013

(54) DISPLAYING DOCUMENTS BASED ON AUTHOR PREFERENCES

(71) Applicants: Jeffrey Murray, Mountain View, CA (US); Shawn Villaron, San Jose, CA (US); Hannes Ruescher, Palo Alto, CA (US)

(72) Inventors: Jeffrey Murray, Mountain View, CA (US); Shawn Villaron, San Jose, CA (US); Hannes Ruescher, Palo Alto, CA (US)

(73) Assignee: Microsoft Corporation, Redmond, WA (US)

(21) Appl. No.: 13/528,139

(22) Filed: Jun. 20, 2012

(51) Int. Cl. G06F 17/00; G06F 3/041

(52) U.S. Cl. 715/212; 715/273; 715/275; 715/243

(57) ABSTRACT

An author of a document may be enabled to specify viewing preferences for displaying a document in a reading view. The author may be enabled to define or select among available options for document viewing preferences such as transitions, animations, display of selected elements, layout features, embedded objects, and comparable ones. A reader of the document may be enabled to specify similar viewing preferences on their end. The author's preferences may also include customization of viewing rules based on a device, application, or version of application through which the document is viewed. In case of conflict between the author's and reader's preferences, one may prevail depending on permission levels and similar attributes.

### BACKGROUND

Modern software applications enabling creation, editing, and presentation of various documents allow a multitude of capabilities including, but not limited to, hideable notes, animation (in static document elements or in transition between pages), combination of graphics, audio, video, and text, etc. While an author may be able to take advantage of one or more of such capabilities, he or she may not necessarily desire a reader to view all aspects of a document. Furthermore, device, application, application-version capabilities may cause a document to be presented differently from the way it was created. Thus, an author may not have any control over how a document looks when it is viewed on another computing device through a different application or different version of the same application.

For example, a document may be presented by a presenter in a presentation view. The presentation view may be, for example, a slide show presented on a large scale projector or display screen, and the slide show may include various graphics, transitions, animations, sounds, movies, narrations and other objects that may complement the presentation and enhance the viewer's consumption of the content as it is presented. The presenter may control the transitions and animations as he or she presents the content. Additionally, the presenter may verbally explain the content of the document in the presentation view, add notes to the slides, and may also include audio and video animations alongside textual content during the presentation. However, the original author of the slide show may wish to have control over which aspects are presented and which are not, or how some aspects are presented.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a system for enabling an author to specify viewing preferences for displaying a document in a reading view. The author may be enabled to define or select among available options for document viewing preferences such as transitions, animations, display of selected elements, layout features, embedded objects, and comparable ones. A reader of the document may be enabled to specify similar viewing preferences on their end. The author's preferences may also include customization of viewing rules based on a device, application, or version of application through which the document is viewed. In case of conflict between the author's and reader's preferences, one may prevail depending on permission levels and similar attributes.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example scenario of a presentation mode between users in a collaborative environment, according to embodiments;

FIG. 2 illustrates conceptually use of author and reader preferences in determining how a document is viewed by a person other than the author generating the document;

FIG. 3 illustrates an example presentation view and reading view of a document, according to embodiments;

FIG. 4 illustrates conceptually author preferences setting different rules for viewing a document based on viewing device type;

FIG. 5 illustrates an user interface for selecting reading view preferences, according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of enabling an author to select preferences for displaying a document in a reading view, according to embodiments.

### DETAILED DESCRIPTION

As briefly described above, a system is provided for enabling an author of a document to specify reading view preferences for displaying document features in a reading view of a document. A document presented in a presentation view may include animated features, transitions, and other aspects that enhance the readability and the reader's consumption of the document. When the document is converted to a reading view, the features may be excluded, bypassed, or otherwise modified in order to display the substantive content the reading view. The system may enable an author to control how the document is viewed in a reading view and how features of the document may be displayed in the reading or presentation view.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

According to some embodiments, a touch-enabled or gesture-enabled input device and display screen may be utilized for viewing documents and receiving input from a user over a user interface. The touch input device and display screen may utilize any technology that allows touch input by a user to be recognized. For example, some technologies may include, but are not limited to: heat, finger pressure, high capture rate cameras, infrared light, optic capture, tuned electromagnetic induction, ultrasonic receivers, transducer microphones, laser rangefinders, shadow capture, and the like. The user interface of a touch-enabled or gesture-enabled device may display content and documents associated with word processing applications, presentation applications, spreadsheet applications and web page content, and menus of actions for interacting with the displayed content. A user may use gestures to interact with the user interface to access, view and edit the content, such as documents, tables, spreadsheets, charts, lists, and any content (e.g., audio, video, etc.). The touch-enabled or gesture-enabled input device may make use of features specific to touch or gesture enabled computing devices, but may also work with a traditional mouse and keyboard. A touch input and/or gesture, such as a tap or swipe action as used herein may be provided by a user through a finger, a pen, a mouse, or similar device, as well as through predefined keyboard entry combinations or a voice command.

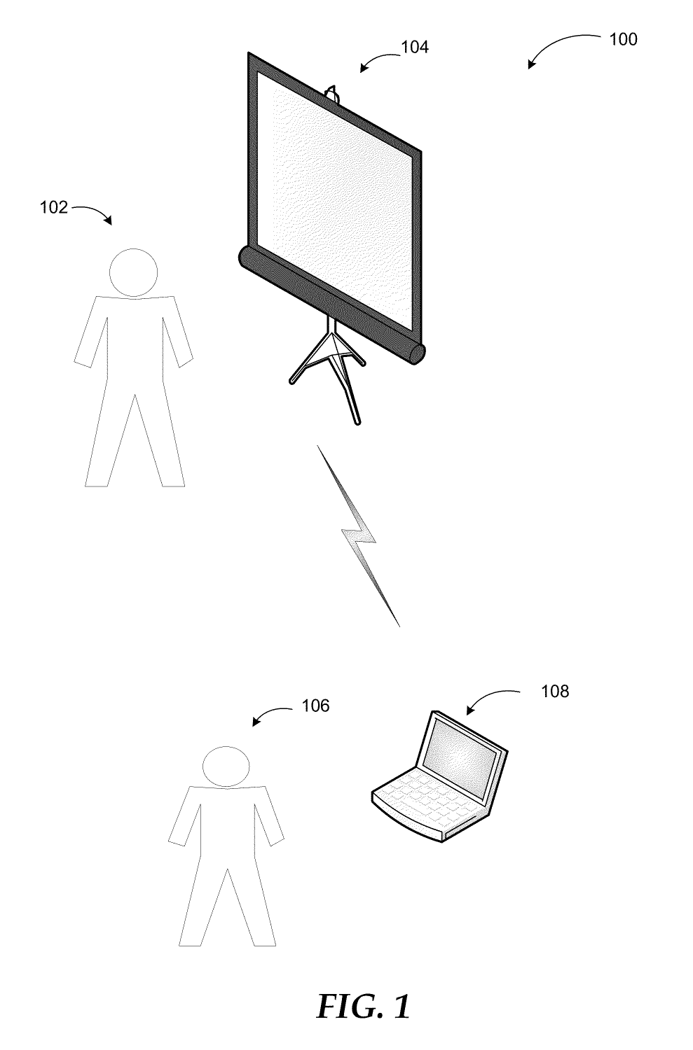

FIG. 1 illustrates an example scenario of a presentation mode in a collaborative environment. In an example scenario of a presentation mode in a collaborative environment, as illustrated in diagram 100, a presenting user (the “author”) 102 may display a presentation view of a document, which may be created using a presentation application, such as a slide show presentation, for example. The presentation view may also be for other types of documents created in other applications such as a word processing application, a spreadsheet application, an email application, a calendar application, and/or a webpage design application for the purpose of presenting to one or more viewers. The presentation view of the document may be printed, displayed live on a computer, and/or projected onto a large display screen 104, and may be navigated through at the command of the author 102.

A document in a presentation view may include various graphics, transitions, animations, sounds, movies, narrations and other objects that may complement the presentation and enhance the viewer's consumption of the content as it is presented. For example, during a slide show presentation, animated transitions may be utilized when moving between slides. Additionally, animated transitions may be utilized to display content as it enters and exits from the slide. For example a new bullet point, additional textual content, and graphical content may be animated as it appears on the slide. The transformations may be controlled by the author as the author presents the material in the presentation view. In some scenarios, the author 102 may include audio and video objects alongside textual content during the presentation. Further, while the author presents the presentation to one or more viewers, the author may add live narration and notes to the slides.

In an example scenario, the document may be viewed by a reader 106 through the same or a different application at a computing device such as personal computer 108. For example, the document may be transmitted through an online conference or downloaded by the reader 106. The document may be presented on the personal computer 108 in reading view employing a more condensed view of the content of the document compared to the live presentation by the author 102. When the document is viewed in a reading view, some of the features from the presentation view, such as transitions, animations, graphics and narrations may be lost, bypassed, and/or displayed differently in order to condense the content for the reading view. In some cases the features of the document from the presentation view may be extraneous and may not add substantive content to the document as it is viewed by a reader, so if they are not displayed in the reading view, it may not affect the reader's understanding of the content. However, in other cases, the animations, transitions, graphics, and narrations may be important for understanding the content and may enhance the reader's consumption of the document and its contents. Therefore, the author 102 may wish to control how the reader views the document in the reading view and to specify whether the reader views certain transitions, animations, graphics, narrations and notes.

In a system according to embodiments, the author 102 may define a set of reading view display preferences so the reading view of the document includes the features of the presentation view that the author 102 specifies. The author 102 may be able to control the reading view of the document so that the reader 106 views the document as the author intends, and features that the author 102 thinks are important may be displayed in the reading view of the document.

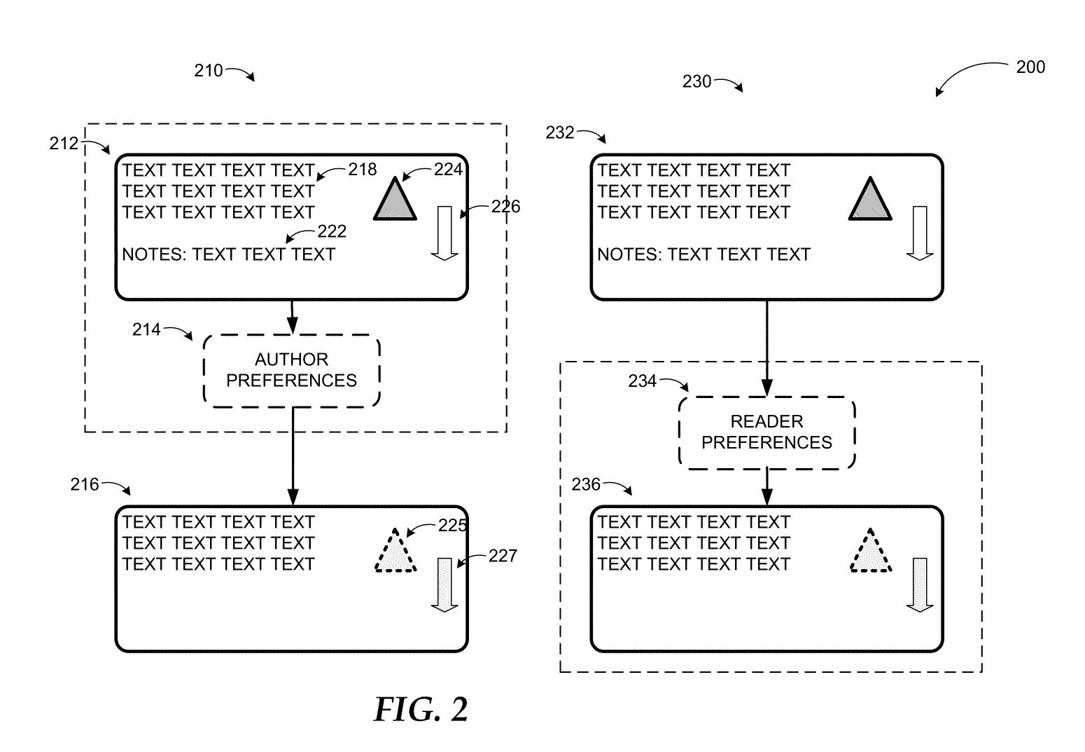

FIG. 2 illustrates conceptually use of author and reader preferences in determining how a document is viewed by a person other than the author generating the document. As shown in diagram 200, a document 212 may include textual content 218, graphical content 224, animations 226, and notes 222. An author of the document may wish not to display or display in a modified form some of these contents and features when the document is viewed by another reader. Thus, the author may specify viewing preferences 214, which may be used to determine how the document is displayed for the other reader as document 216 with removed notes 222, modified graphics 225, and modified animations 227. For example, a color scheme, a shading scheme, a textual scheme, and similar ones may be used differently when the document 216 is presented to the reader compared to the generated document 212 in the example scenario 210.

In the example scenario 230, generated document 232 may be displayed according to reader specified preferences 234 as document 236 on the reader's computing device. For example, the reader may choose not to view animations, use a gray scale color scheme instead of full set of colors, etc.

In other embodiments, both the author's preferences 214 and the reader's preferences 234 may be taken into consideration. If there is a conflict, the author's or the reader's preferences may prevail depending on system configuration, permission levels of the author or the reader, etc. In yet other embodiments, capabilities and/or limitations of the computing device displaying the document for the reader, the application rendering the document, and/or a version of the application rendering the document may also be taken into consideration. For example, the author may be enabled to define viewing preferences based on one or more of the computing device, the application, and/or the version of the application. The author may also define the preference based on reader type. For example, readers within the author's team may be enabled to view the author's notes (e.g., narration) while readers outside the team may not be allowed to view the notes. In resolving such conflicts, other factors such as the computing device, the application, etc. may also be considered.

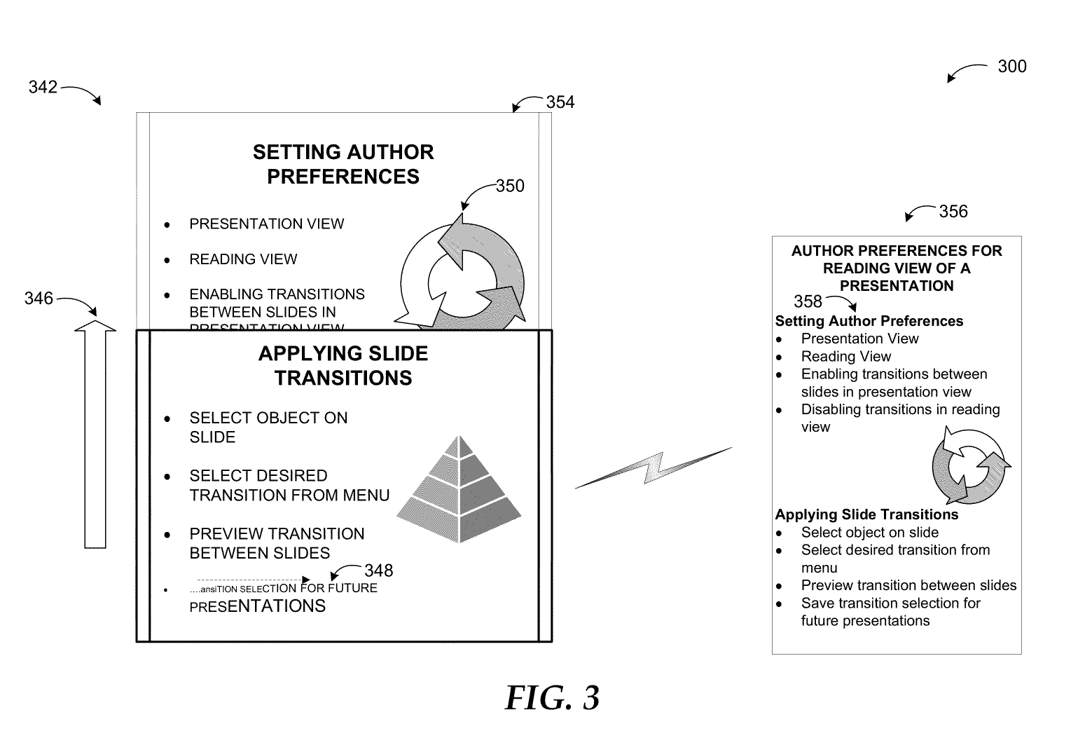

FIG. 3 illustrates an example presentation view and reading view of a document, according to embodiments. As discussed above in conjunction with FIGS. 1 and 2, a document may be viewed by a reader in a presentation view and in a reading view. The presentation view 342 of the document may be a slide show for example, and the presentation view may include features, such as animations, slide transitions 346, textual animations 348, graphics 350, narrations, and audio/visual effects that enhance the consumption of the document. The reading view 356 of the document may be a word processing document or other outline view of the document which may display the substantive content of the document, such as the textual content 358 in a more condensed format.

Typically, when a document is converted into the reading view 356, features such as transitions and animations from the presentation view 342 may be skipped or lost in order to enhance the readability of the document. Often times, the animated features of the document in the presentation view 342 may be superfluous to the textual content 358 of the document and may be used to enhance the presentation without adding important content. Therefore, it does not affect the textual content 358 if the animated features are lost or skipped when the document is converted to the reading view. In other scenarios, the animated features of the presentation view 342 add substantive content to the document, and it may be prudent for these features to be displayed when the document is viewed in a reading view.

In a system according to embodiments, the author of the document may define a set of preferences to control how the reader views the document in the reading view 356, such as whether the reader views transitions, animations, graphics, narrations and notes associated with the document. For example, the author may determine that certain animated features are important for viewing and understanding the content of the document, and the author may specify that the important animated features should be displayed when the reader views the document in the reading view 356. The author may also be able prioritize certain animations and transitions, so that items the author prioritizes as important are not skipped or lost when the reader views the document. Lower priority items or items specified as unimportant by the author may be skipped to increase readability, thus enabling the reader to focus on the content, and not to be distracted by extraneous animations that do not add to the content.

In an example embodiment, the author may set reading view display preferences for an individual feature for specifying whether the individual feature should be included when the document is viewed in the reading view 342. In an example scenario, the author may know that certain animations, such as a slide transition 346, can be left out to enhance the viewing speed in the reading view 342, while other animations may be needed for understanding the document. The author may select each animation individually to specify whether it should be included or excluded when the document is viewed in the reading view. In another example, the user may select an individual item, such as a graphic 350 displayed on a slide 342, and specify that the selected graphic 350 should be included in the reading view. Thus, graphics specifically selected to be included may be viewed in the reading view 356, and other unselected graphics may be skipped. The user may also select an individual transition, such as a textual animation 348 and specify that the textual animation 345 should be skipped when the document is viewed in the reading view 356. The author may navigate through the document while in the presentation view 342 and may individually select each object in the presentation view 342 of the document to individually specify whether each object should be included or discarded when viewed in the reading view 342.

In another embodiment, the author may globally set the reading view preferences for specifying whether certain features should be included or excluded. The author may select a category or type of animated feature, and may specify reading view display preferences for the selected feature category throughout the entire document. For example, the author may determine that none of the transitions and animations in the presentation view adds any substantive value to the document. The author may specify that all animations and transitions from the presentation view should be excluded when the document is viewed in the reading view 356, and all graphics and narrations should be included.

The author may also include narrations or audio files that accompany the document in the presentation view 342 and may specify that some or all the narrations and audio/visual files should be available in the presentation view. The narrations and audio/visual files may be embedded in the document in the reading view 356 such that they may be made available at the option of the reader during the reading view 356. An indicator may be provided in the reading view to indicate embedded features, such as the narrations and audio/visual files, and the reader may select the indicator to open the file while viewing the document in the reading view 356. Additionally, the author may determine that the narrations and/or audio/visual files may only be accessible during the reading view 356 and not during the presentation view 342 so as to enhance the readability of the document when not in the presentation view 342. For example, the narration may supplement the document in the reading view 356 for when the presenter is not able to verbally explain the document as in a live presentation during the presentation view 342. Likewise, the author may be able to add or enable additional features and content so they may be only available in the reading view 356 and not in the presentation view 342.

In an additional embodiment, the author may specify that the reading view of the document should display certain animated and transitional features depending on the platform and software utilized for viewing the document. If the document is viewed on a handheld device such as a smart phone or a tablet as opposed to a full screen device, such as personal computer or laptop, the author may specify how the document should be viewed on each type of device. For example, the author may specify that transitions, animations and graphics may be skipped or left out when the document is viewed on a handheld device, but these features may be included if the document is viewed in a full screen. The author may also specify reading view preferences based on software versions and applications, such that certain features may be included or excluded based on the type of software or software version on which the reading view of the document is viewed. As discussed previously, the author may specify the settings globally for the features, or the author may individually specify whether each feature should be included or excluded when viewed on different platforms and utilizing certain software.

In a further embodiment, author and reader preferences may be specified for gesture based input on touch enabled devices. For example, in a presentation view of the document on a touch enabled device, a gesture such as a swiping or tapping action may be utilized to display animations individually, for example bringing in each new object one at a time, making a new paragraph appear on the slide, and transitioning to a new slide as some examples. In the reading view 356 of the document, if the author has specified to discard all animations, then a gesture such as a swiping or tapping action may be utilized to make all the content of the document appear at the same time, thus skipping all the animations. Additionally, if some animations have been selected to be included in the reading view by the author, then the swiping or tapping action on the reading view of the document may operate to display each included animation. In a further example, a tap action on the reading view may be used to display animations and transitions individually, while a swipe action may be used to bypass all animations and transitions and open all of the content concurrently. If, however, the author has specified for certain animations, graphics, and transition features to be displayed, then a swipe action may not operate to bypass the features and may operate as a tap action to individually display the animations, graphics, and/or transitions in the reading view 216.

In yet another embodiment, the author may include a notes feature for providing additional information to textual content in the presentation view 342 of the document, and may specify that the notes feature should be included in the reading view 356 of the document. A swipe in a certain direction or a type on a certain portion of the document in presentation view 342 may display the author's notes during presentation view. In the reading view, an icon may appear on the screen to indicate that the author has included notes, and in reading view 356 the reader can tap or swipe the icon to display the notes.

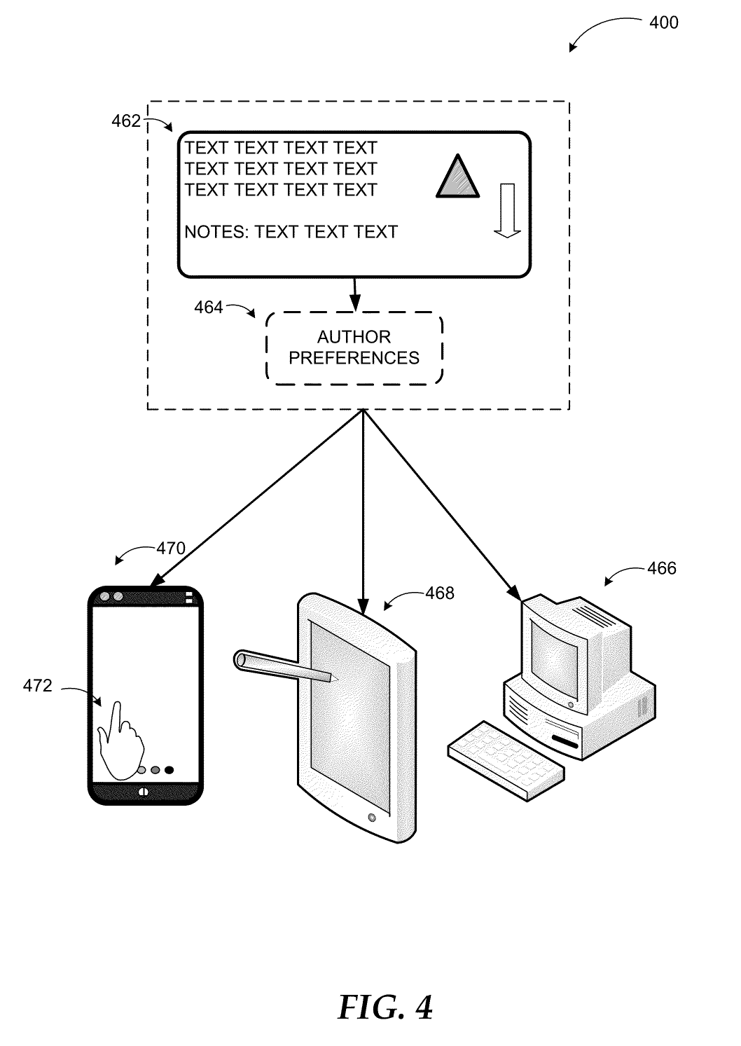

FIG. 4 illustrates conceptually author preferences setting different rules for viewing a document based on viewing device type. As shown in diagram 400, a document 462 may be associated with author preferences 464 defining how the document 462 is to be viewed in a reading mode by other readers.

In some embodiments, the author preferences 464 may define custom rules depending on a type of computing device to be used for viewing the document 462. For example, the document may be displayed differently on a desktop computer 466 than on a touch-capable slate computer 468. The document may be displayed yet differently on a touch or gesture capable (472) handheld device 470. Each of these devices may have different processing capabilities, display capabilities, and/or networking capabilities. Thus, for a computing device with limited network capability or slower processing capacity, features of the document such as embedded audio or animations may be bypassed. Similarly, display characteristics of the various devices may also determine which features of the document are to be removed, modified, or added.

For example, in touch or gesture capable devices, the touch/gesture interaction may be affected by the author's preferences. The author may specify a particular swipe action for changing slides in a slide show, for example. The swipe action may be modified in a reading view that includes automatic changing of the slides. Additionally, the original swipe action may be left-to-right (or right-to-left), but if the device displaying the document has a display that is oriented differently, the swipe action may be changed to a vertical swipe.

In some embodiments, the preference settings may be per document or per application on the reader side. The author preferences, on the other hand, may be per document since the author may wish to define those for each document that is sent to different readers. Also, the authoring user interface (for setting preferences) may be centralized or per object.

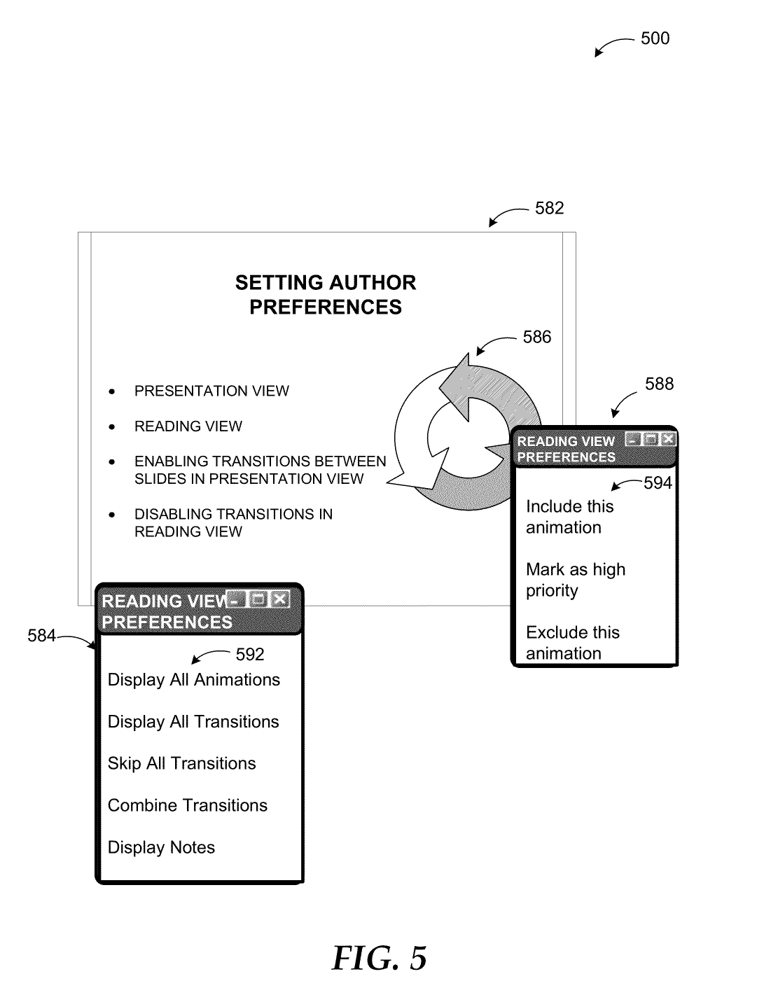

FIG. 5 illustrates a user interface for selecting reading view preferences, according to embodiments. As discussed above, the author may set reading view preferences for individual features specifying whether the feature should be included when the document 582 is viewed in the reading view. In another embodiment, the author may also globally set the reading view preferences for specifying whether certain features should be included or excluded.

In an example embodiment shown in diagram 500, a user interface 588 and 584 may be provided for enabling the author to select feature display preferences by providing a centralized set of options 592 and a per object set of options 594. Using the centralized user interface 584, the author may globally set the reading view preferences for specifying the inclusions or exclusion of categories or types of the document features. For example, the author may specify that all animations and transitions from the presentation view should be excluded when the document 582 is in the reading view, and all graphics and narrations should be included. The centralized user interface 584 may be a separate user interface associated with the application itself, such that the user can open the reading view preferences user interface and set preferences for the entire document 582. The centralized user interface 584 may provide a list of available preferences for the selected object, such as show animations, skip transitions, combine all slides animations into one click, and display notes, as a few examples.

In an additional embodiment, a per object user interface 588 may be provided for enabling the author to set preferences individually on a per object basis. For example, the author may right click, or otherwise select an object 586 in the document 582, and the per object user interface 588 associated with the selected object 586 may appear for providing a per object set of options 594. The per object user interface 588 may provide a list of available preferences for the selected object 586, such as include this animation, mark as high priority, and exclude this animation, as a few examples. The per object user interface 588 and the centralized user interface 584 may take on a variety of forms, such as a dialog box, pop-up window, drop down window, and a menu bar as some examples.

In a further embodiment, the author's reading view preferences may be saved per document and per application. For example, if the author wants to save reading view display preferences per application, then preferences the author sets for the slide show may be saved and applied to additional slide shows created by the author in the presentation application. In an example scenario, the author may designate that in every slide show created by a presentation application, when the slide show is converted into a reading view, animations and transitions should never be included, or alternatively, animations and transitions should always be combined into one click. Likewise, the author may specify that designated reading view preferences for a current slide show are only to be applied to the current slide show, and may not be permanent setting for applying to future slide shows.

The example systems and configuration in FIG. 1 through 5 have been described with specific examples, user interfaces, applications, and interactions. Embodiments are not limited to systems according to these examples. A system for setting preferences for displaying features in a reading view of a document may be implemented in configurations employing fewer or additional components and performing other tasks. Furthermore, specific protocols and/or interfaces may be implemented in a similar manner using the principles described herein.

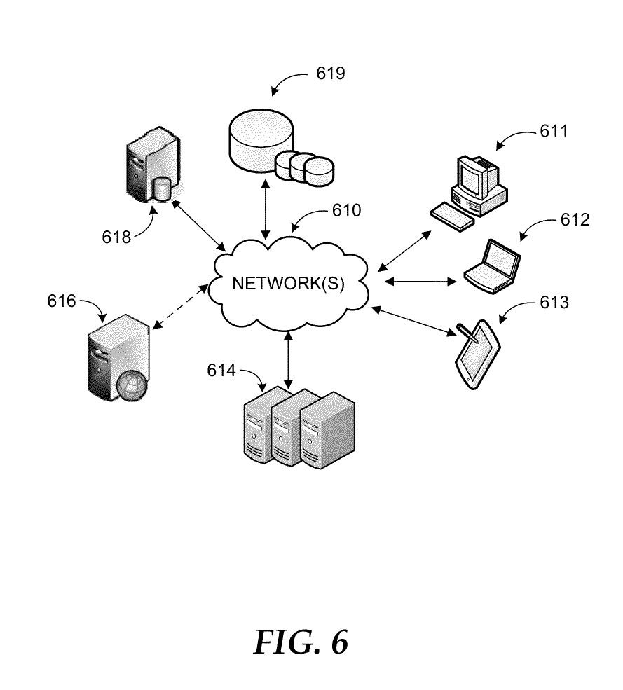

FIG. 6 is an example networked environment, where embodiments may be implemented. A system for setting preferences for displaying features in a reading view of a document may be implemented via software executed over one or more servers 616 such as a hosted service. The platform may communicate with client applications on individual computing devices such as a smart phone 613, a laptop computer 612, or desktop computer 611 (‘client devices’) through network(s) 610.

Client applications executed on any of the client devices 611-613 may facilitate communications via application(s) executed by servers 616, or on individual server 614. An application executed on one of the servers may facilitate setting preferences for displaying features in a reading view of a document. The application may retrieve relevant data from data store(s) 619 directly or through database server 618, and provide requested services (e.g. document editing) to the user(s) through client devices 611-613.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a platform for setting preferences for displaying features in a reading view of a document. Furthermore, the networked environments discussed in FIG. 6 are for illustration purposes only. Embodiments are not limited to the example applications, modules, or processes.

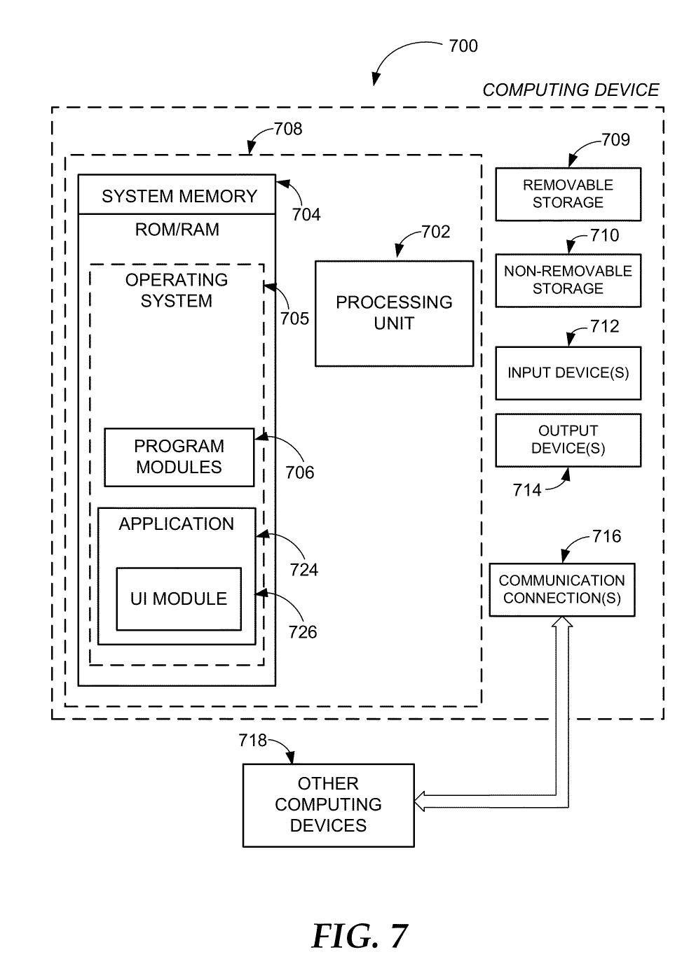

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any computing device executing an application for enabling an author and/or a reader to set preferences for displaying features in a reading view of a document according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as an application 724 and a user interface module 726.

The application 724 may facilitate creation, editing, and/or viewing of a document, and may be a word processing application, a spreadsheet application, an email application, a calendar application, a note taking application, a presentation application, and similar ones. Through the user interface module 726, the application 724 may present a user interface to the author and/or the reader for enabling them to specify how certain features, including graphics, animations, slide transitions, textual transitions, audio/visual features, narrations and notes, of a document is to be presented. Application 724 and user interface module 726 may be separate applications or integrated modules of a hosted service. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

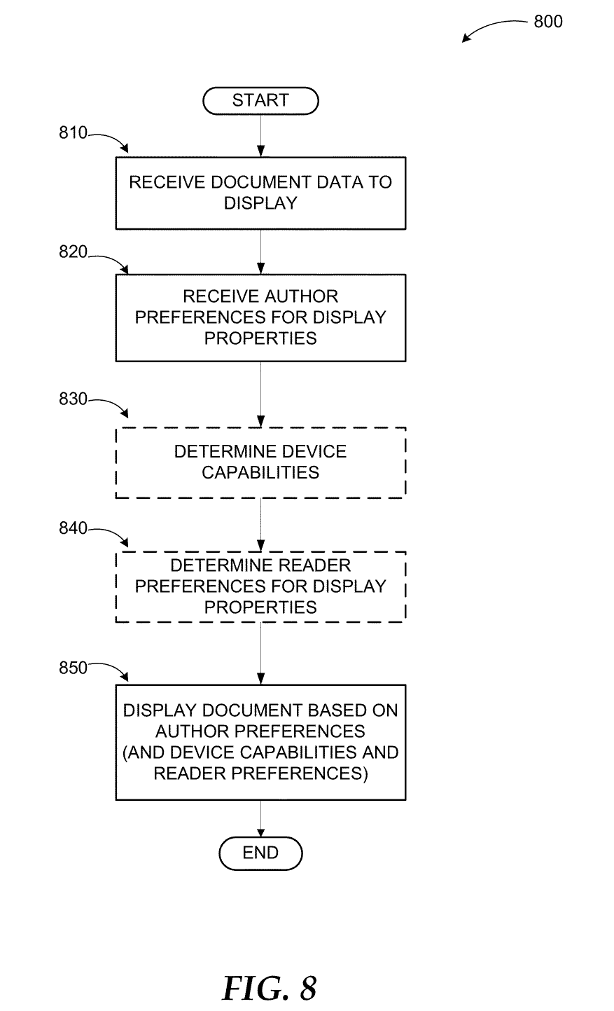

FIG. 8 illustrates a logic flow diagram for a process 800 of enabling an author to select preferences for displaying a document in a reading view, according to embodiments. Process 800 may be implemented on a computing device or similar electronic device capable of executing instructions through a processor.

Process 800 begins with operation 810, where a document may be received at a reader's computing device for display. The reader's computing device may also receive a set of preferences set by the author of the document at operation 820. The author's preferences may be provided through metadata associated with the document or other mechanisms. At optional operation 830, capabilities and/or limitations of the reader's computing device may be determined In some embodiments, the author's preferences for viewing the document may be associated with the capabilities and/or limitations of the reader's computing device.

At optional operation 840, the reader's preferences for viewing the document may be determined The reader's preferences may be specified through an application rendering the document or retrieved from reader attributes associated with the reader's credentials. At operation 850, the document may be displayed based on the author-specified viewing preferences and the reader's preferences and/or device capabilities. In other embodiments, capabilities and/or limitations of an application rendering the document or a version of the application may also be taken into consideration. In case of conflict, the author's preferences may prevail in further embodiments.

The operations included in process 800 are for illustration purposes. Displaying a document based on author/reader preferences and/or device capabilities may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for displaying a document based on viewing preferences defined by an author of the document, the method comprising:
receiving document data to display;
receiving the viewing preferences defined by the author associated with one or more features of the document; and
displaying the document based on the received author viewing preferences, wherein at least one of the features in the displayed document is different from a corresponding feature in the generated document.

2. The method of claim 1, further comprising:
receiving viewing preferences defined by a reader of the document; and
displaying the document based on the received author viewing preferences and the reader viewing preferences.

3. The method of claim 2, wherein the author viewing preferences prevail in case of a conflict with the reader viewing preferences.

4. The method of claim 2, further comprising:
determining at least one from a set of: a device capability, an application capability, and an application version associated with displaying the document; and
displaying the document based on the received author viewing preferences, the reader viewing preferences, and one or more of the device capability, the application capability, and the application version associated with displaying the document.

5. The method of claim 1, further comprising:
providing a user interface for enabling the author to one of select among default preferences, customize default preferences, and define new preferences for viewing the document.

6. The method of claim 5, further comprising:
providing the user interface as one of a centralized user interface enabling the author to define global viewing preferences for the document and a per object user interface enabling the author to define viewing preferences for individual objects.

7. The method of claim 1, further comprising:
one or more of: removing a feature, adding a feature, and modifying a feature based on the author viewing preferences, wherein modifying the feature includes employing one of a color scheme, a shading scheme, and a textual scheme.

8. The method of claim 1, further comprising:
modifying one or more of: an animation, a slide transition, a textual transition, a graphic, a narration, a note, an audio effect, a layout feature, and a video effect based on the author preferences in the displayed document.

9. The method of claim 1, further comprising:
saving the author viewing preferences to an application in which the document is created; and
applying the saved author viewing preferences to future documents created using the application.

10. The method of claim 1, further comprising:
saving the author viewing preferences to document as metadata.

11. The method of claim 1, further comprising:
enabling modification of a touch/gesture interaction of a touch/gesture capable computing device displaying the document based on the author viewing preferences.

12. A computing device for enabling an author to specify viewing preferences for a document created on the computing device when the document is viewed on other computing devices, the computing device comprising:
a memory storing instructions;
a processor coupled to the memory, the processor executing an application in conjunction with the stored instructions, wherein the application is configured to:
enable one of creation and editing of the document;
provide a user interface for specifying one or more author viewing preferences;
receive the author viewing preferences associated with one or more features of the document;
provide the document with the author viewing preferences to another computing device for displaying the document based on the specified author viewing preferences, wherein at least one of the features in the displayed document is different from a corresponding feature in the generated document.

13. The computing device of claim 12, wherein the application includes one or more of: a presentation application, a word processing application, a spreadsheet application, an email application, a calendar application, a note taking application, and a webpage design application.

14. The computing device of claim 12, wherein the application is further configured to:
enable the document to be displayed at the other computing device based on one or more of the author viewing preferences, reader viewing preferences specified at the other computing device, a capability of the other computing device, an application rendering the document at the other computing device, and a version of the application rendering the document, wherein the author viewing preferences prevail in case of a conflict.

15. The computing device of claim 12, wherein the application is further configured to:
enable the author to specify the author viewing preferences based on a credential of a reader viewing the document at the other computing device.

16. The computing device of claim 12, wherein the other computing device is a touch/gesture capable computing device and the application is further configured to:
modify a touch/gesture interaction at the other computing device based on an author viewing preference, the interaction including one or more of a tap action and a swipe action.

17. The computing device of claim 12, wherein the application is further configured to:
combine all animated features from the presentation view into one touch based action on the touch enabled device, wherein the touch based action is one of: a touch and a swipe.

18. The computing device of claim 12, wherein the reading view application is further configured to:
enable presentation of a user interface at the other computing device displaying the author viewing preferences such that a reader viewing the document can one of specify and modify their reader viewing preferences.

19. A computer-readable memory device with instructions stored thereon for displaying a document based on viewing preferences defined by an author of the document, the instructions comprising:
receiving document data to display;
receiving the viewing preferences defined by the author associated with one or more features of the document along with the document;
receiving viewing preferences defined by a reader of the document;
determining at least one from a set of: a device capability, an application capability, and an application version associated with displaying the document; and
displaying the document based on the received author viewing preferences, the reader viewing preferences, and one or more of the device capability, the application capability, and the application version associated with displaying the document, wherein at least one of the features in the displayed document is different from a corresponding feature in the generated document.

20. The computer-readable memory device of claim 19, wherein at least one of the author viewing preferences and the reader viewing preferences are specified as one of global settings for the entire document and per object settings for individual objects within the document.
